(19) United States
(12) Patent Application Publication
(10) Pub. No.: US 2007/0262961 A1
(43) Pub. Date: Nov. 15, 2007

(54) Method for selecting functional tables through a touch-sensitive button key

(75) Inventor: Steven Chen, Changhua (TW)

Correspondence Address: BRUCE H. TROXELL, SUITE 1404, 5205 LEESBURG PIKE, FALLS CHURCH, VA, 22041, US

(73) Assignee: E-LEAD ELECTRONIC CO., LTD.

(21) Appl. No.: 11/431,058

(22) Filed: May 10, 2006

(51) Int. Cl. G06F 3/041

(52) U.S. Cl. 345/173

(57) ABSTRACT

A method for selecting functional tables through a touch-sensitive button key aims to facilitate selection and execution of an item on a functional table according to the pressing location of a user's finger on a touch-sensitive pad. The method includes at least the following steps: mapping areas of a touch-sensitive pad against different menus; displaying a menu of a corresponding functional table when touching of a finger on a selected area of the touch-sensitive pad is detected; changing a selected and marked item when the finger moves on the selected area; changing the menu displayed on the screen to another menu when the finger moves to another area; and executing the function of a selection item when it is executable. Thus users can select items easier on the opened functional table.

### BACKGROUND OF THE INVENTION

1. Field of the Invention

The invention relates to a method for selecting functional tables through a touch-sensitive button key and particularly to a method to facilitate selection and execution of an item on a functional table.

2. Description of the Prior Art

The functions of electronic products are abundant and more complicated these days. Selection of different functions usually has to be done through button keys spreading on varying locations. These button keys are constrained by the surface area and generally marked in an abbreviated manner. As a result, users often cannot remember and forget most of the functions even after having read the entire operation manual. They usually can use only some basic functions. It is a pity. Moreover, many functional operations are set according to some preferred product functional output. Users could inadvertently hit selection items of some preferred settings and result in abnormal outputs, and cannot reset to the normal condition due to unfamiliar to the use method. Some users become very frustrated or even return the products.

To remedy the aforesaid problem many vendors adopt menu on the screen to do functional selection. For instance, through a five-way key which can be moved up, down, left and right to select functional tables, and a dedicated input key to do data entry, operation convenience can be greatly improved.

While the conventional five-way key can provide some convenience in operation selection, by moving the key upwards, downwards, leftwards and rightwards to select the items on a marked functional table, the key has to be depressed many times, some even by dozens, to move from the item at the top to the bottom on the screen. To transfer from one function to another function, it has to be done by moving level by level upwards to the main directory, then moving downwards to a desired functional table to do selection and input. Although such an approach is easier to operate and understand than the conventional dispersed button keys, it is a tedious process.

### SUMMARY OF THE INVENTION

In view of the aforesaid concerns, it is an object of the present invention to provide a method for selecting functional tables through a touch-sensitive button key. This method provides users a simpler operation to select and execute an item on a functional table. This method mainly includes a functional table directory which is divided into a plurality of menus and a touch-sensitive pad which is divided into a plurality of areas. Each area corresponds to a menu. A screen is provided to display the selection items of the functional table. The selection items of the same menu is located on the same area. When a user's finger slides on the areas of the touch-sensitive pad, the menus on the screen are driven to scroll. By depressing the touch-sensitive pad a desired selection item can be input. The method of the invention includes at least the following steps:

mapping the areas of a touch-sensitive pad against different menus;

displaying menus of a corresponding functional table on a screen when touching of a user's finger on a selected area of the touch-sensitive pad is detected;

changing a selected and marked item when the finger moves on the selected area; changing the menu displayed on the screen to another menu when the finger moves to another area; and

executing functions of the selected item when it is executable.

By means of the procedures set forth above, users can select and execute items on a functional table easier.

In one aspect, in the step of “changing the selected and marked item when the finger moves on the selected area, the menu displayed on the screen being changed to another menu when the finger moves to another area” means that when one selection item in the menus displayed on the screen is selected at least a menu corresponding to one area is changed to another menu.

In another aspect, the functional table includes a total function directory which is jointly formed by the menus. The menus are organized in a tree-like structure.

In yet another aspect, in the step of “changing the selected and marked item when the finger moves on the selected area, the menu displayed on the screen being changed to another menu when the finger moves to another area”, the changed menu is a sub-directory of the input selection item, and the screen displays the items of the sub-directory.

In still another aspect, in the step of “executing the function when an executable item is selected” the executable item is a selection item on the lowest level of the tree-like structured total function directory.

In yet another aspect, the touch-sensitive pad is a two-stage induction touch-sensitive pad. To execute input of a selected item, user's finger depresses the touch-sensitive pad when the selected item is marked. The pressure has to reach a preset pressure value detectable by the touch-sensitive pad.

In yet another aspect, the touch-sensitive pad includes at least one touch-sensitive pad which has at least one area. The screen displays the condition of the menus of the functional table corresponding to the area.

In yet another aspect, the touch-sensitive pad includes a plurality of areas each corresponding to a selected menu, and the screen displays the menu.

In yet another aspect, the touch-sensitive pad includes a plurality of areas which are divided into a plurality of rows or columns.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention in an operating condition.

FIG. 2 is a schematic view of the functional table of the invention.

FIG. 3 is a flow chart-1 of the invention.

FIG. 4 is a flow chart-2 of the invention.

FIG. 5 is a flow chart-3 of the invention.

FIG. 6 is a flow chart-4 of the invention.

FIG. 7 is a flow chart-5 of the invention.

### DESCRIPTION OF THE PREFERRED EMBODIMENTS

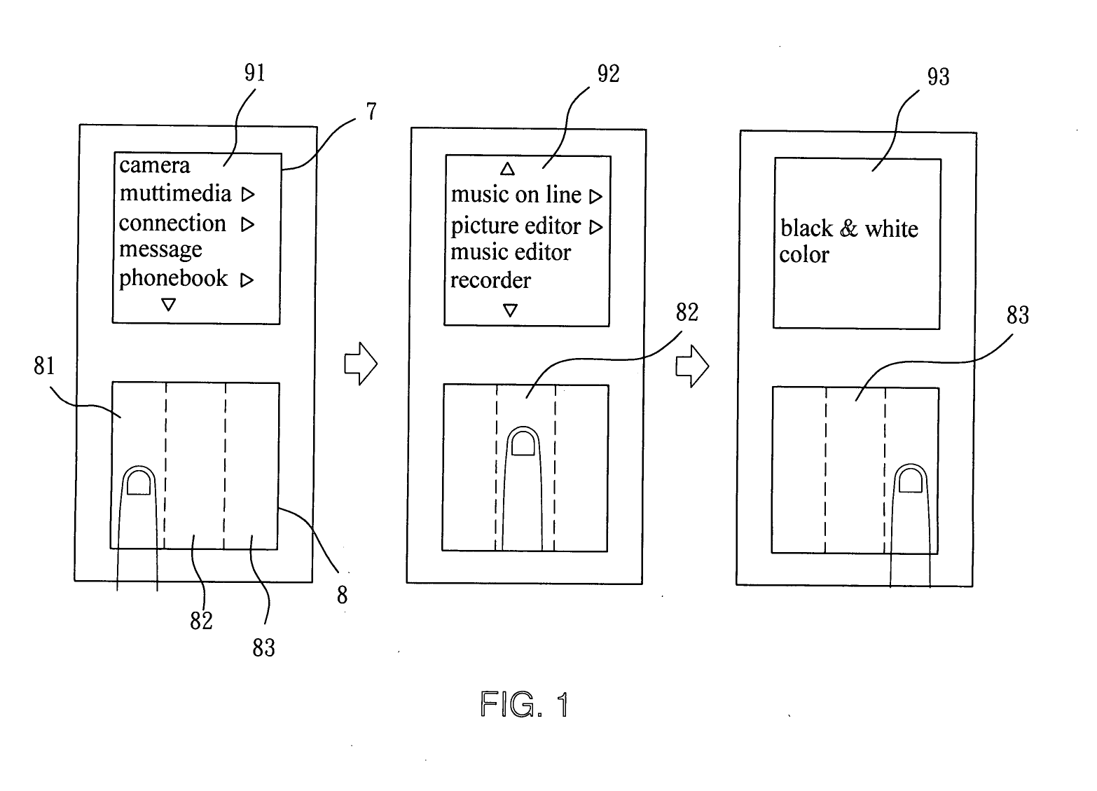

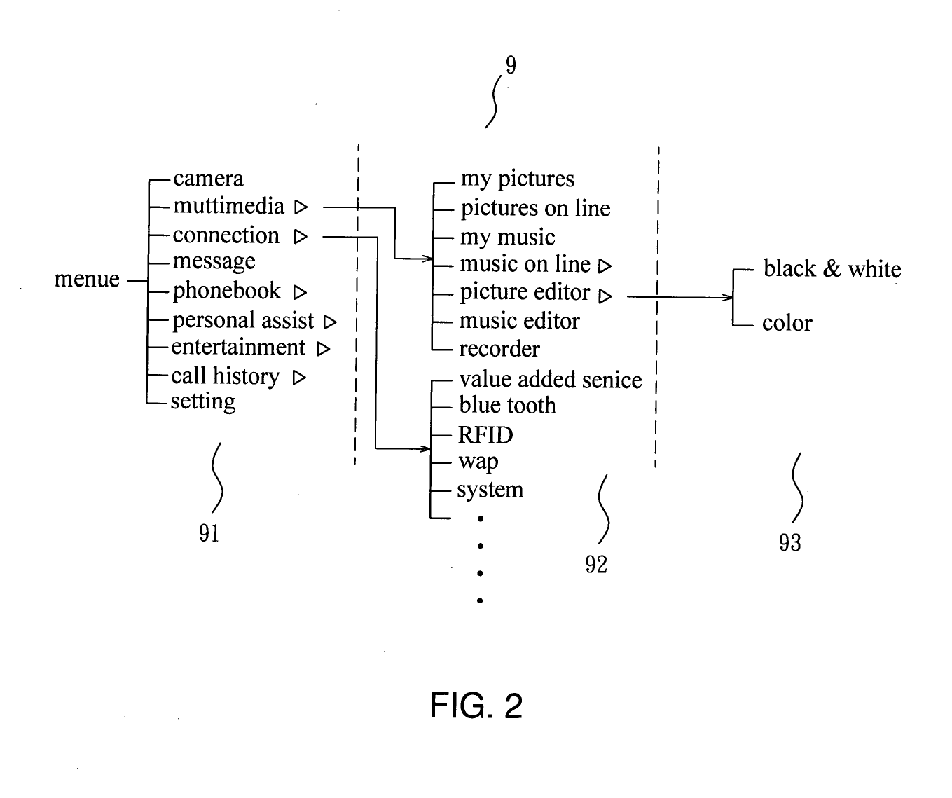

Referring to FIGS. 1, 2 and 3, the method for selecting functional tables through a touch-sensitive button key of the invention mainly divides menus of a functional table 9 according to the classification of selection items into a plurality of menus 91, 92 and 93 and has a touch-sensitive pad 8 which is divided into a plurality of areas 81, 82 and 83 corresponding to the menus 91, 92 and 93. The touch-sensitive pad 8 is a two-stage induction pad to detect the pressure of finger depression. A screen 7 is provided to display the menus 91, 92 and 93. The menus 91, 92 and 93 are located in the areas 81, 82 and 83. When a user's finger slides on the areas 81, 82 and 83, the menus 91, 92 and 93 on the screen 7 can be scrolled. Depressing the touch-sensitive pad 8 can perform input of a selected item. The method of the invention includes at least the following steps:

Step 10: Divide the touch-sensitive pad 8 into a plurality of areas 81, 82 and 83 corresponding to different menus 91, 92 and 93 (referring to FIG. 1);

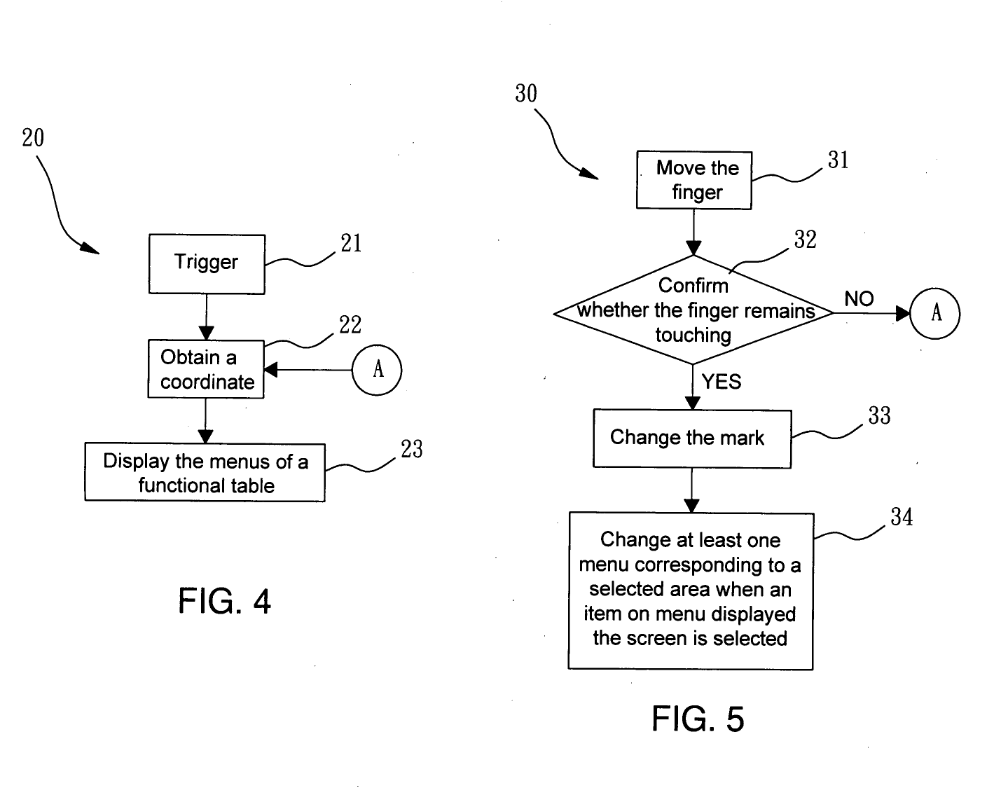

Step 20: The screen displays a corresponding menu of a functional table when a user's finger touches a selected area (referring to FIG. 4). This step further includes: (1) triggering (step 21) a detection action when the finger touches the touch-sensitive pad 8; (2) obtaining the coordinate (step 22) of the finger on the touch-sensitive pad 8 to process and get the location of a corresponding menu of the functional table; (3) displaying the menus 91, 92 and 93 of the functional table (step 23) on the screen 7 corresponding to the areas 81, 82 and 83 where the finger is located (referring to FIG. 1);

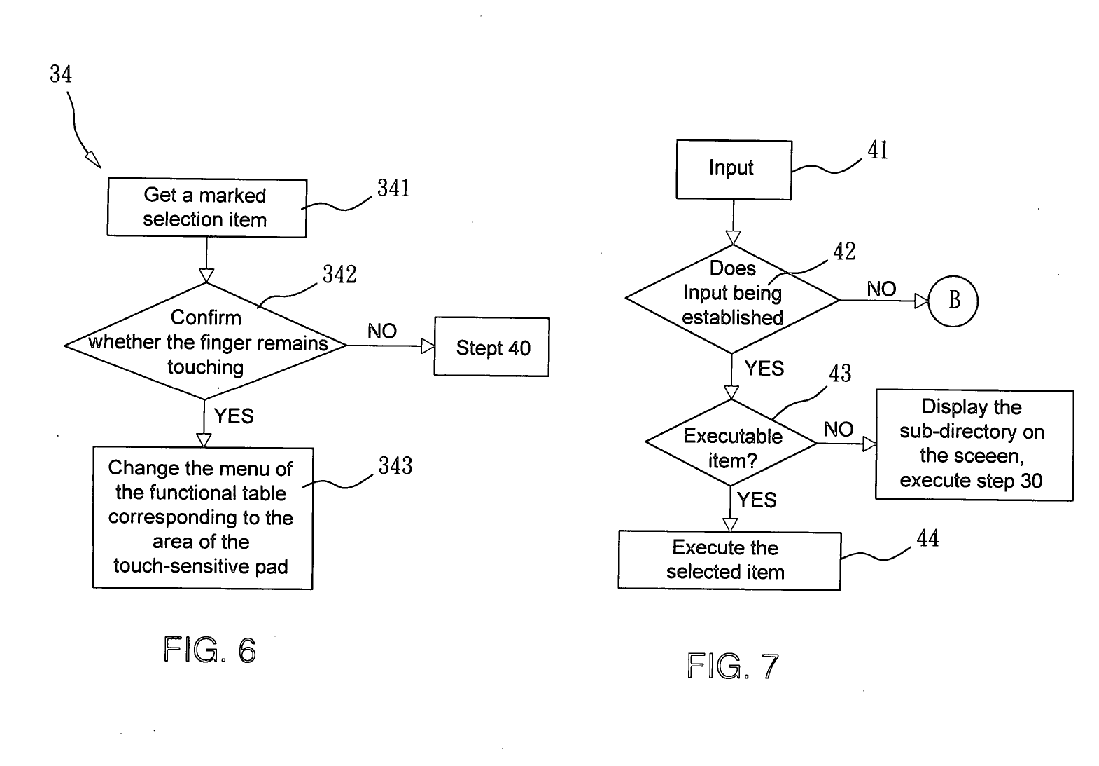

Step 30: When the finger moves to another area, the selected and marked menu displayed on the screen changes to another menu with the changing finger (referring to FIG. 5). This steps further includes: (1) obtaining the moving displacement of the finger on the touch-sensitive pad 8 when the finger moves (step 31); (2) determining whether the finger remains touching the touch-sensitive pad 8 (step 32); if positive, execute step 33; otherwise execute step 22; (3) altering marking position of the menus on the screen according to upward or downward movement of the finger (step 33); (4) changing at least one of the menus to another corresponding to a selected area when one of the selection items displayed on the screen is being selected (step 34, also referring to FIG. 6); this step further includes: (1): getting a marked selection item (step 341) on a selected menu according to the moving displacement of the finger; (2) determining whether the selection item selected by the finger has a sub-function directory (step 342); if positive execute step 343; otherwise execute step 40; (3) changing the functional table directory corresponding to the area of the touch-sensitive pad (step 343);

Step 40: Execute the function of an executable item if the selection item is the executable item (referring to FIG. 7). This step further includes: (1) input (step 41) by getting an input signal via detecting the depression of the finger on the touch-sensitive pad 8 (or in cooperating with an input key); (2) establishing input (step 42) by determining whether the input signal exists (through the touch-sensitive pad 8 to detect the depression signal of the finger or the signal of an input key); if positive, execute step 43; otherwise execute step 30; (3) determining whether the selection item is an executable item (step 43); if positive execute step 44; otherwise display the sub-directory table on the screen and execute step 30; (4) executing the selected selection item (step 44).

By means of the steps set forth above, users can easily open a functional table and select desired items.

According to the selection method of the invention previously discussed the functional table has a total function directory jointly formed by the menus 91, 92 and 93 each being organized in a tree-like structure.

In one aspect, the touch-sensitive pad 8 includes at least one touch-sensitive pad which includes areas 81, 82 and 83. The screen can display conditions of the menus 91, 92 and 93 of the functional table 9 corresponding to the areas 81, 82 and 83.

In another aspect, the touch-sensitive pad 8 is divided into a plurality of areas 81, 82 and 83 which are further divided into a plurality of rows or columns.

While the embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

### LEGEND OF THE DRAWINGS

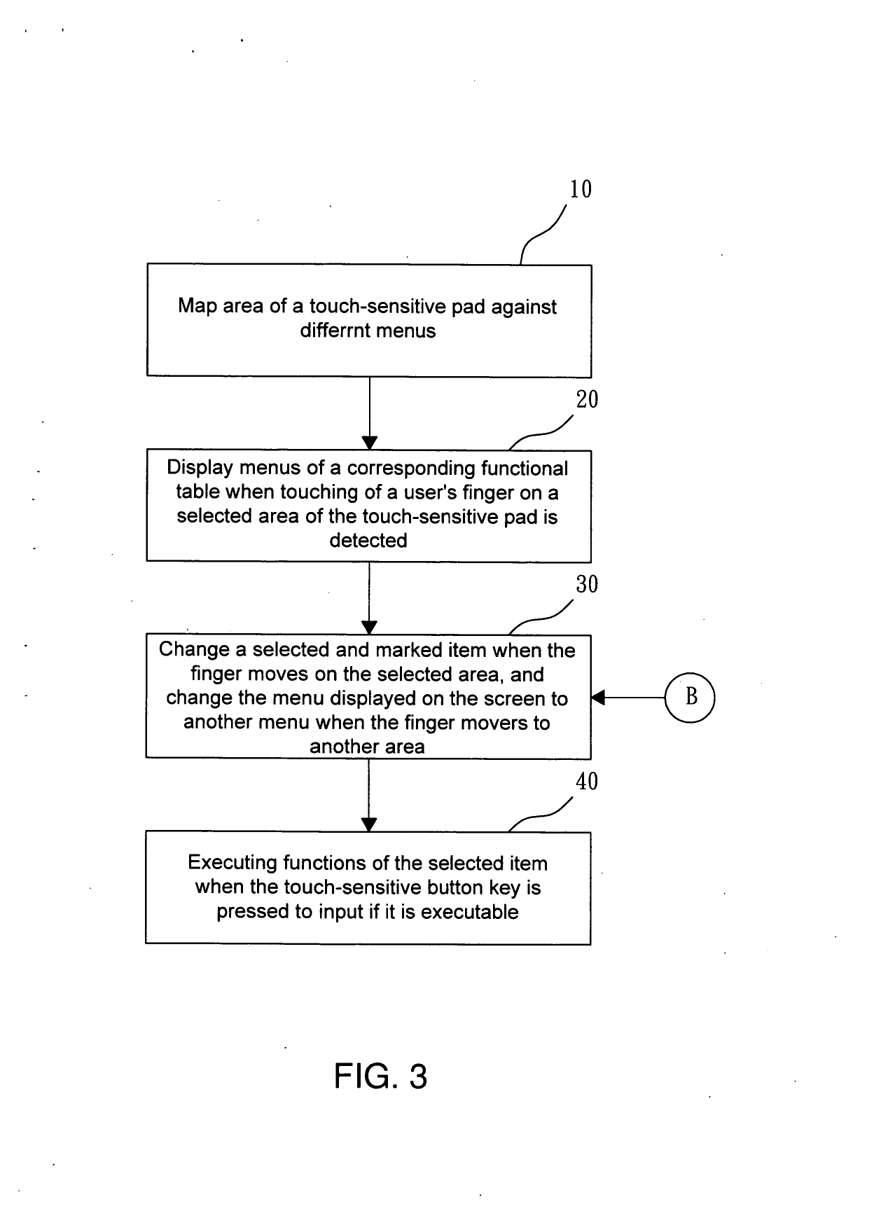

FIG. 3

10—Map areas of a touch-sensitive pad against different menus,
20—Display menus of a corresponding functional table when touching of a user's finger on a selected area of the touch-sensitive pad is detected,
30—Change a selected and marked item when the finger moves on the selected area, and change the menu displayed on the screen to another menu when the finger moves to another area,
40—Execute functions of an executable item when the selected item is executable.
   FIG. 4
21—Trigger,
22—Obtain a coordinate,
23—Display the menus of a functional table
   FIG. 5:
31—Move the finger,
32—Confirm whether the finger remains touching,
33—Change the mark,
34—Change at least one menu corresponding to a selected area when an item on menu displayed the screen is selected.
   FIG. 6:
341—Get a marked selection item
342—Determine whether a sub-directory exists?→(No) Step 40
343—(Yes) Change the menu of the functional table corresponding to the area of the touch-sensitive pad.
   FIG. 7:
41—Input,
42—Does Input being established?
43—(Yes) Executable item?→(No) Display the sub-directory on the screen, execute step 30
44—(Yes) Execute the selected item

I claim:

1. A method for selecting functional tables through a touch-sensitive button key, comprising at least the steps of:
mapping areas of a touch-sensitive pad against different menus;
displaying menus of a corresponding functional table on a screen when touching of a user's finger on a selected area of the touch-sensitive pad is detected;
changing a selected and marked item when the finger moves on the selected area, and changing one menu displayed on the screen to another menu when the finger moves to another area; and
executing functions of the selected item when the touch-sensitive button key is pressed to input if it is executable.

2. The method of claim 1, wherein the selected and marked item changes when the finger moves in the areas, the menu displayed on the screen being changed to another menu when the finger moves to another area, at least one menu corresponding to a selected area being changed to another menu when one selection item in the menus displayed on the screen is selected.

3. The method of claim 1, wherein the functional table has a total function directory jointly formed by the menus, the menus being organized in a tree-like structure.

4. The method of claim 1, wherein the selected and marked item is changed when the finger moves in the areas, the menu displayed on the screen being changed to another menu when the finger moves to another area, the changed menu being input to a sub-directory of the selected item.

5. The method of claim 1, wherein execution of the selected item starts when the selected item is executable, the executable item is a selection item at a lowest level of a total function directory organized in a tree-like manner.

6. The method of claim 1, wherein the touch-sensitive pad is a two-stage induction touch-sensitive pad to execute a selection item by depressing the touch-sensitive pad with the finger on the marked selection item at a pressure reaching a detectable preset pressure value.

7. The method of claim 1, wherein the touch-sensitive pad includes at least one touch-sensitive pad each having at least one area, the screen displaying conditions of the menus of the functional table corresponding to the area.

8. The method of claim 1, wherein the touch-sensitive pad is divided into a plurality of areas each corresponding to a menu, the screen displaying a corresponding selection item.

9. The method of claim 8, wherein the areas of the touch-sensitive pad consist of a plurality of columns.

10. The method of claim 8, wherein the areas of the touch-sensitive pad consist of a plurality of rows.
